(19) United States
(12) Patent Application Publication
(10) Pub. No.: US 2025/0224927 A1
(43) Pub. Date: Jul. 10, 2025

(54) FLOATING-POINT LOGARITHMIC NUMBER SYSTEM SCALING SYSTEM FOR MACHINE LEARNING

(71) Applicant: Cassia.AI Inc., Fremont, CA (US)

(72) Inventor: James Tandon, Fremont, CA (US)

(73) Assignee: Cassia.AI Inc., Fremont, CA (US)

(21) Appl. No.: 19/091,344

(22) Filed: Mar. 26, 2025

Related U.S. Application Data
(63) Continuation of application No. 18/045,804, filed on Oct. 11, 2022.
(60) Provisional application No. 63/254,053, filed on Oct. 8, 2021.

(51) Int. Cl. G06F 7/487; G06F 5/01; G06F 7/483; G06F 7/485

(52) U.S. Cl. CPC G06F 7/4876; G06F 5/012; G06F 7/4833; G06F 7/485

(57) ABSTRACT

An integrated circuit includes a hardware inexact floating-point logarithmic number system (FPLNS) multiplier. The integrated circuit access registers containing a first floating-point binary value and its first logarithmic binary value and a second floating-point binary value and its second logarithmic binary value, each being in an FPLNS data format. The FPLNS multiplier configured to multiply the first and second floating-point binary values by adding the first logarithmic binary value to the second logarithmic binary value to form a first logarithmic sum, shifting a bias constant by a number of bits of the mantissa of the first floating-point binary value to form a first shifted bias value, subtracting a correction factor from the first shifted bias value to form a first corrected bias value, and subtracting the first corrected bias value from the first logarithmic sum to form a first result.

### CROSS-REFERENCE TO RELATED APPLICATIONS

The present application is a continuation of and seeks the benefit of U.S. application Ser. No. 18/045,804, filed Oct. 11, 2022 and entitled “Floating-Point Logarithmic Number System Scaling System for Machine Learning,” which claims the benefit of U.S. Provisional Patent Application No. 63/254,053 filed Oct. 8, 2021 and entitled “Inexact Floating-point Logarithmic Number System,” both of which are incorporated herein by reference.

### FIELD OF THE INVENTION

Embodiments discussed herein related generally to accelerated processing and more particularly to implementation of floating-point number format with a biased logarithmic number system (FPLNS) for efficient calculations.

### BACKGROUND

Current machine learning (ML) accelerator chips execute trillions of multiply-accumulate (MAC) operations per second, and billions of activation functions per second. In order to achieve such speeds, individual chips may consume hundreds of watts of power. As machine learning models become more complicated, they are consuming larger amounts of power. However, there is a push to move ML accelerators to the edge so power consumption has become a limiting factor.

Until 2019, major companies developed a machine learning solution that would optimize a process that was internal to that company, thus saving cost per month. Since then, more and more companies have been developing products that use machine learning for distribution. In order to take advantage of deep learning algorithms, these custom products have a need for their own embedded machine learning accelerator. At this time, such accelerators include GPUs from NVidia and AMD, and field programmable gate arrays (FPGAs) from Xilinx and Intel. Newer custom ML processors such as from Google, NVidia, ARM, and others have been developed.

These ML accelerator devices, while capable of high performance, consume incredible amounts of power which make them unwieldy. Case in point: running a 4 W TPU on a cell phone with a 3000 mA-hr battery at full speed will deplete the battery in less than an hour. It is known that power consumption can be reduced in exchange for reduced performance, however, machine learning applications with higher computation demands are progressively being pushed to the edge.

### SUMMARY

An example system comprises an integrated circuit including a hardware inexact floating-point logarithmic number system (FPLNS) multiplier configured to perform FPLNS functions. The integrated circuit may be configured to access registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits, access registers containing a second floating-point binary value and a second logarithmic binary value of the second floating-point binary value, each of the second floating-point binary value and the second logarithmic binary value being in an FPLNS data format, the second floating-point binary value in the FPLNS format, multiply by the FPLNS multiplier, the first floating-point binary value and the second floating-point binary value, the FPLNS multiplier configured to: add, by the FPLNS multiplier, the first logarithmic binary value to the second logarithmic binary value to form a first logarithmic sum, shift a bias constant by a number of bits of the mantissa of the first floating-point binary value to form a first shifted bias value, subtract a correction factor from the first shifted bias value to form a first corrected bias value, and subtract the first corrected bias value from the first logarithmic sum to form a first result. The integrated circuit being further configured to perform an antilogarithm on the first result to generate a multiplication result of the multiplication of the first floating-point binary value and the second floating-point binary value.

In some embodiments the system includes a processor configured to: convert the first floating-point binary value to the first logarithmic binary value, the first floating-point binary value being in the FPLNS format, the processor configured to convert the first floating-point binary value to the first logarithmic binary value comprising the processor configured to: determine a base-2 logarithm of a quantity of one plus a mantissa of the first floating-point binary value to form a first log quantity, add the first log quantity to the exponent of the first floating-point binary value to form a first total, and subtract the bias constant from the first total to form the first logarithmic binary value, and convert the second floating-point binary value to the second logarithmic binary value, the first floating-point binary value being in the FPLNS format, the processor configured to convert the second floating-point binary value to the second logarithmic binary value comprising the processor configured to: determine a base-2 logarithm of a quantity of one plus a mantissa of the second floating-point binary value to form a second log quantity, add the second log quantity to the exponent of the second floating-point binary value to form a second total, and subtract the bias constant from the second total to form the first logarithmic binary value.

In various embodiments, the multiplication result being in the FPLNS format. The bias constant may be 2^{(E-1)}−1, where E is the number of bits in the exponent of the first floating-point binary value in the FPLNS format. In some embodiments the FPLNS multiplier retrieves the correction factor from one or more registers that do not contain the first floating-point binary value, the first logarithmic binary value, the second floating-point binary value, and the second logarithmic binary value. The correction factor may be within a range of 0.04 to 0.06.

In some embodiments the exponent bits of the first floating-point binary value in the FPLNS format are positioned such that the highest exponent bit of the exponent bits is closest to the sign bit and the lowest exponent bit is closest to the mantissa bits, the mantissa bits of the first floating-point binary value of the FPLNS format being positioned such that the highest mantissa bit of the mantissa bits is closest to the exponent bits and the lowest mantissa bit is farthest from the exponent bits. Similarly, in various embodiments, the exponent bits of the first logarithmic binary value in the FPLNS format are positioned such that the highest exponent bit of the exponent bits is closest to the sign bit and the lowest exponent bit is closest to the mantissa bits, the mantissa bits of the first logarithmic binary value of the FPLNS format being positioned such that the highest mantissa bit of the mantissa bits is closest to the exponent bits and the lowest mantissa bit is farthest from the exponent bits.

In various embodiments, the FPLNS multiplier is further configured to divide a third floating-point binary value and a fourth floating-point binary value, the third floating-point binary value and the fourth floating-point binary value being in the FPLNS data format, the FPLNS multiplier being configured to divide the third floating-point binary value and the fourth floating-point binary value by:
subtracting, by the FPLNS multiplier, a third logarithmic binary value of the third floating-point binary value from the fourth logarithmic binary value of the fourth floating-point binary value to form a first logarithmic difference, shifting the bias constant by a number of bits of the mantissa of the third floating-point binary value to form the second shifted bias value, subtracting the correction factor from the second shifted bias value to form a second corrected bias value, and adding the second corrected bias value from the first logarithmic sum to form a second result, and the integrated circuit being further configured to perform an antilogarithm on the second result to generate a division result of the division of the third floating-point binary value and the fourth floating-point binary value.

An example method comprises accessing registers by an integrated circuit, the registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits, the integrated circuit including a hardware inexact floating-point logarithmic number system (FPLNS) multiplier configured to perform FPLNS functions, accessing registers by the integrated circuit containing a second floating-point binary value and a second logarithmic binary value of the second floating-point binary value, each of the second floating-point binary value and the second logarithmic binary value being in an FPLNS data format, the second floating-point binary value in the FPLNS format, multiplying, by the FPLNS multiplier, the first floating-point binary value and the second floating-point binary value, the multiplication comprising: adding, by the FPLNS multiplier, the first logarithmic binary value to the second logarithmic binary value to form a first logarithmic sum, shifting a bias constant by a number of bits of the mantissa of the first floating-point binary value to form a first shifted bias value, subtracting a correction factor from the first shifted bias value to form a first corrected bias value, and subtracting the first corrected bias value from the first logarithmic sum to form a first result, the method further performing an antilogarithm on the first result to generate a multiplication result of the multiplication of the first floating-point binary value and the second floating-point binary value.

### BRIEF DESCRIPTION OF THE DRAWINGS

FIG. 1 depicts an example semiconductor chip 104 that includes an FPLNS multiplier.

FIG. 2 depicts an FPLNS system in some embodiments.

FIG. 3 is an example of an FPLNS format for a floating-point value

FIG. 4 is an example of an FPLNS format for a logarithmic value.

FIG. 5A is a plot of log₂(1+X) and X+C where C=0 in an example.

FIG. 5B is a plot of log₂(1+X) and X+C where C=0.0473 in an example.

FIG. 6 is an example of a FPLNS format with a radix point defined at the arrow for the fixed-point base-2 logarithm.

FIG. 7A depicts a flowchart for multiplying two logarithmic binary values using the FPLNS process where the correction factor MU is a constant.

FIG. 7B depicts a flowchart for multiplying two logarithmic binary values using the FPLNS process where the correction factor MU is a variable.

FIG. 8A depicts a flowchart for dividing two logarithmic binary values using the FPLNS process where the correction factor MU is a constant.

FIG. 8B depicts a flowchart for dividing two logarithmic binary values using the FPLNS process where the correction factor MU is a variable.

FIG. 9A depicts an example process of FPLNS logarithm base C in some embodiments.

FIG. 9B depicts another example process of FPLNS logarithm base C in some embodiments.

FIG. 10 depicts exponentiation process 1000 in some embodiments.

FIG. 11 depicts an example process of classification 1100 utilizing fplns functions in some embodiments.

FIG. 12 is a block diagram illustrating a digital device capable of performing instructions to perform tasks as discussed herein.

### DETAILED DESCRIPTION

In various embodiments, a library of approximate computation arithmetic functions for ML computation significantly reduces circuit complexity with less than 1% accuracy loss across models (e.g., ResNet and MobileNetV1). Some embodiments enable: 90% smaller circuit size, 68% less power, and 55% less latency in 45 nm.

Approximate computing arithmetic algorithms discussed herein may perform, for example, multiplication, division, exponentiation, and logarithms. These operations may be the basis for many activation functions. These approximate computation techniques may also synergize with many other commonly used approximation techniques deployed today such as pruning and weight compression.

Various embodiments described herein utilize a number format that combines a floating-point number format with a biased logarithmic number system (FPLNS number system). This allows the same bits to store both the original number and its logarithm with the same set of bits. A special biasing factor may minimize average error which may maximize model accuracy. In one example, this allows a model trained traditionally, or even provided by a 3rd party, to be used with FPLNS computation inference engine with less than 1% model accuracy loss whereas traditional LNS methods can suffer from 5% model accuracy loss or greater during inference.

In various embodiments, floating-point accuracy in addition/subtraction computations is improved or optimized over the prior art. Further, there is improved accuracy in approximate FPLNS multiplication/division computations over previous implementations (e.g., with worst case relative error magnitude of 8%). Further, systems and methods discussed herein may perform inexact logarithm and exponentiation functions in hardware using only bit permutation and fixed-point addition which enables higher-order activation functions like softmax.

It will be appreciated that with the FPLNS system described herein, no look-up tables or piecewise-linear tables are required.

The customers we will target are system-on-chip (SoC) designers and field programmable gate array (FPGA) integrators that develop or deploy ML accelerator intellectual property (IP) for implementation in edge products. The IP cores often include hundreds to thousands of MAC cores for fast computation.

There is also a need for fast computation of the softmax activation function. With several thousand fabless semiconductor SoC companies and tens of thousands more companies that use FPGA for integration, ML accelerator cores have been re-implemented repeatedly to focus solely on ML acceleration. With the industry consolidating in the coming years, only the most power and efficient ML accelerator companies will thrive in edge devices.

Previous research has shown that several machine learning algorithms are resilient to floating-point formats that used reduced precision. The core of any machine learning model relies on many multiply-accumulate operations so there is potential for optimization of power.

Various embodiments are implemented at a hardware level in either field programmable gate arrays (FPGAs) or application-specific integrated circuits (ASICs). In some embodiments, there is a reduction in clock cycles when implemented in software. Some embodiments of functions discussed herein may be implemented as IP cores (e.g., Verilog cores) to be licensed to FPGA and ASIC hardware producers/developers.

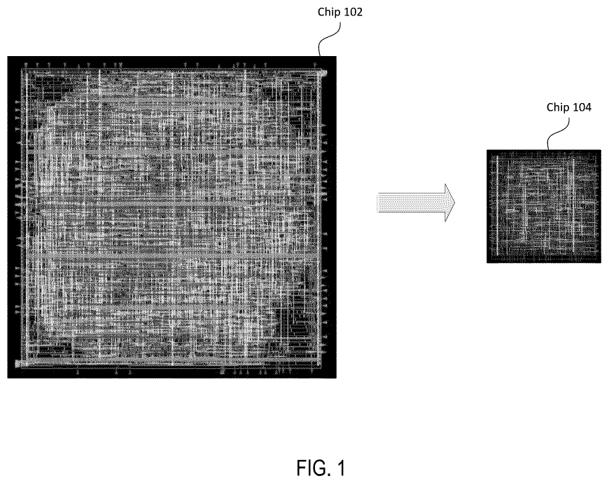

FIG. 1 depicts an example semiconductor chip 104 that includes an FPLNS multiplier. Various embodiments described herein significantly reduce the total hardware complexity of multiplication and exponentiation through the use of a hybrid floating-point/logarithmic-number (FPLNS) multiplier. This reduction in digital complexity potentially can lead to significant savings in power consumption while increasing performance with minimal loss of ML model accuracy.

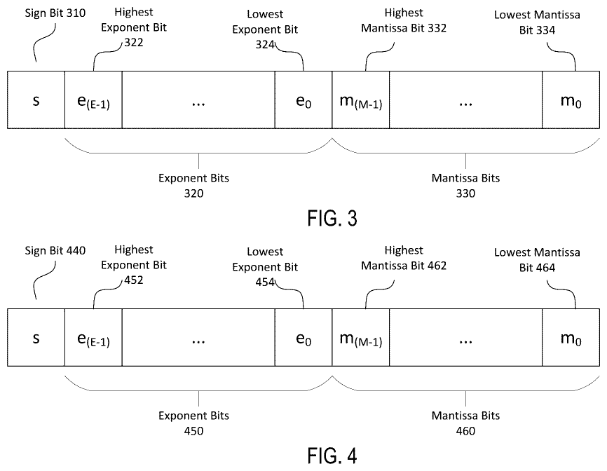

Both chip 102 and chip 104 in this example include a routed 32-bit multiplier in 45 nm. The original multiplier is on chip 102. An FPLNS multiplier with implementation discussed herein (e.g., that utilizes FPLNS data storage format as discussed herein and shown in FIGS. 3 and 4) is on chip 104. Chip 104 is significantly smaller than chip 102 owing to the FPLNS multiplier system implemented in the hardware.

In the example of FIG. 1, chip 104 includes a size reduction of 90% for 32-bit floating-point multiplier in 45 nm over chip 102. Further, chip 104 in FIG. 1 has a power reduction of 68% for 32-bit floating-point multiplier in 45 nm over chip 102. Moreover, chip 104 has latency reduction of 55% for 32-bit floating-point multiplier in 45 nm over chip 102. Further, in the example of FIG. 1, chip 104 has a 6.85 times improvement in performance to power over chip 102 due to the FPLNS multiplier on chip 104. Utilizing the FPLNS system of chip 104 in the example of FIG. 1, chip 104 has 18.6 times performance over area when compared to chip 102.

Further, in the example of FIG. 1, with a node of 45 nm, the multipliers may be compared as follows:

| FP32 Standard Multiplier of Chip 102 | FPLNS Multiplier of Chip 104 |
|---|---|
| Cells: 4624 | Cells: 423 |
| Latency: 3.5 ns | Latency: 1.6 ns |
| Power: 2.26 mW | Power: 20.722 mW |
| Area: 12,544.0 um2 | Area: 1,474.56 um2 |
| Perf/Pwr: 126.4 MhZ | Perf/Pwr: 856.7 MhZ |
| Perf/Area: 0.0228 Mhz/um2 | Perf/Area: 0.4239 Mhz/um2 |

With a node of 7 nm, the FPLNS chip (e.g., chip 104) may also have significant improvements over a BF16 standard multiplier. The multipliers may be compared as follows:

| BF16 Standard Multiplier of Chip 102 | FPLNS Multiplier of Chip 104 |
|---|---|
| Cells: 598 | Cells: 222 |
| Latency: 1425.12 ps | Latency: 433.16 ps |
| Power: 277 uW | Power: 119 uW |
| Area: 77.0 um2 | Area: 37 um2 |
| Perf/Pwr: 2.533 MhZ/um2 | Perf/Pwr: 18.03 MhZ/um2 |
| Perf/Area: 9.113 Mhz/um2 | Perf/Area: 57.98 Mhz/um2 |

Some embodiments significantly reduce the total hardware complexity of multiplication and exponentiation through the use of a hybrid floating-point/logarithmic-number system (FPLNS). This reduction in digital complexity can lead to significant savings in power consumption while increasing performance but with negligible model accuracy loss. The core of any machine learning model relies on many multiply-accumulate operations so there are improvements for efficiency. Further, the chip 104 has benefits in power, performance, and area over chip 102 without impacting ML model accuracy (e.g., less than 1% accuracy loss proven in both ResNet and MobileNetV1 models).

Previous research has shown that several machine learning algorithms are resilient to floating-point formats that used reduced precision. The core of any machine learning model relies on many multiply-accumulate operations so there is potential for optimization of power.

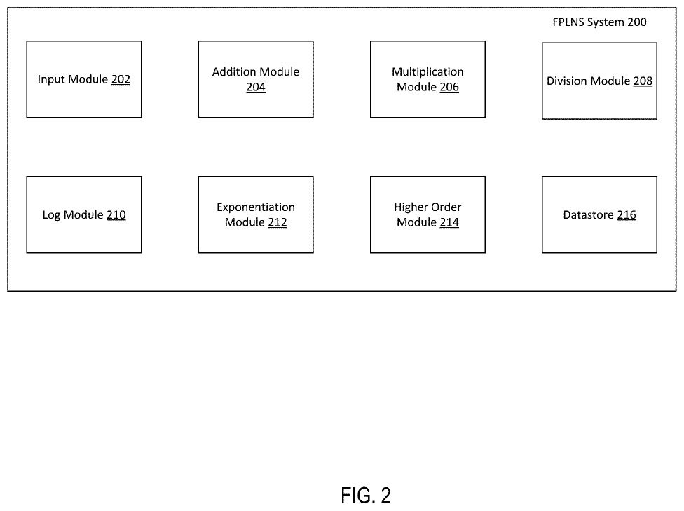

FIG. 2 is an example FPLNS system 300 in some embodiments. The FPLNS system 200 may be integrated within an integrated circuit (e.g., FPGA and/or ASIC) or may be software (e.g., an IP core). The FPLNS system 200 may be implemented within an integrated circuit (e.g., as a FPLNS multiplier) or as an IP core. The FPLNS system 200 may reduce power consumption relative pre-existing systems that perform these calculations. In one example, the power consumption of the integrated circuit may be less than 3 W with greater than 4 Tera Operations Per Second (“TOPS”). In some embodiments, the FPLNS scaling system 300 may be or include an ML accelerator and a compiler (e.g., OONX compiler).

In various embodiments, the FPLNS system trades multiplication and exponentiation accuracy in exchange for reduced logic complexity and/or circuit size. The reduced logic complexity leads to lower power consumption with higher performance. Although operation accuracy suffers, ML model accuracy loss can be less than 1%. The metrics of area, speed, and power are the key determinants of cost in the semiconductor space. There is a trend towards smaller precision floating-point formats because multiplication complexity reduces quadratically with a reduced number of bits in the mantissa of floating-point numbers. In one example, the FPLNS system discussed herein may reduce multiplication to linear complexity with E+5 bits of average precision.

FIG. 3 is an example of an FPLNS format for a floating-point value. The same format may be utilized for a floating-point value and a logarithmic value. FIG. 4 is an example of the FPLNS format defined with a radix point at the arrow for the fixed point base-2 logarithm.

In FIGS. 3 and 4, “s” refers to the sign bit, “e”s refer to the exponent values, and “m”s refer to the mantissa values. The FPLNS data format holds real number and logarithm base-2 simultaneously in the same bits.

In FIG. 3, a floating-point value in this format is equal to (−1)^s*(1+m/(2)^M))*2)^(e-B) such that b=2^(E-1)-1. The sign bit 410 is a 1-bit unsigned int. The e may be an E-bit unsigned int, and m may be an M-bit unsigned int.

In this example, the format uses a biased sign-magnitude format. For a fixed point number represented in the format there is a sign bit, a whole portion (e bits or exponent bits 420 of FIG. 4), and a fraction portion (m bits or mantissa bits 430). They are layered on top of each other. The biassing (bias B), in this example, is equal to 2^{(E-1)}−1.

FIG. 4 is an example of an FPLNS format for a logarithmic value. As discussed herein, the format for the logarithmic value and the floating-point value is the same format. In FIG. 4, a logarithmic value in this format corresponds to e−B+(m+MU)/(2^M). The radix point is between the LSB(e) and the MSB(m). In this example, the format uses a biased sign-magnitude format. For a fixed point number represented in the format there is a sign bit, a whole portion (e bits or exponent bits 450 of FIG. 4), and a fraction portion (m bits or mantissa bits 460) with a radix point between the e bits and the m bits. They are layered on top of each other. The biassing (bias B) is a constant and is equal to 2^{(E-1)}−1. If we have 8 bits for E(E=8), this implies B=127. M in this example is the fraction portion of the fixed-point format. This is biased by the factor Mu (i.e., the correction factor C). The correction factor (Mu) in this example may be between (0.0-.99). In one example, Mu is a value such as 0.043. In various embodiments, 0<=Mu<2^M (e.g., M is the number of bits of the mantissa). Mu may be variable or a constant.

The FPLNS system also specified collection of arithmetic functions for operating on data.

In various embodiments, the hybrid floating-point/logarithmic-number system (FPLNS) represents both the original k-bit floating-point number N and its base-2 logarithm L using the same set of k bits without any extra information. If a digital designer wishes to use L in an operation, then the designer may account for a data-independent bit permutation operation, and an addition of a constant biasing factor B. Because the commonly used floating-point formats are semi-logarithmic formats, a floating-point number can be converted to an approximate logarithm through the use of a bit-permutation and a single fixed-point addition by constant B for the transform to L. Use of the original number N is accomplished by using the traditional floating-point (FP) operations without modification.

Once a hybrid representation of both the number N and its base-2 logarithm L is established, it is possible to implement multiplication and division directly from the biased logarithm by using two fixed-point addition operations and a bit permutation: one addition of the L1 and L2 values, and a second addition of the bias B. Exponentiation and logarithms may also be calculated directly by bit-permutation operations. Transcendental functions for ML may be implemented using Newton's method or a Taylor series. By using FPLNS, it is possible to reduce the complexity of multiplication and exponentiation functions by an order of magnitude. Because the loss in accuracy due to this approximate representation minimally affects ML model accuracy, the power efficiency increases significantly.

A large body of published research exists that demonstrates reduced complexity of multiplication and division using logarithmic number systems (LNS). While multiplication in LNS is improved, performing both multiplication and addition are required for most numerical algorithms. Unfortunately, exact addition in LNS is not easy. Piecewise linear approximations, look-up tables, or other hybrid methods are required to convert between logarithmic and linear domains, or to compute more complicated transcendental functions. Various systems described herein may not utilize look-up tables, or piecewise linear approximations.

Various embodiments of the hybrid floating-point/logarithmic-number system (FPLNS) discussed herein represents both the original k-bit floating-point number N and its base-2 logarithm L using the same set of k bits without any extra information. In one example implementation in some embodiments, if a digital designer wishes to use L in an operation, then the designer may account for a data-independent bit permutation operation, and an addition of a constant biasing factor B. This discussion is based around 32-bit IEEE754, but this representation can be extended to any bit length. Because the commonly used floating-point format is a semi-logarithmic format, it can be converted to an approximate logarithm through the use of a bit-permutation and a single fixed-point addition by constant B for the forward transform to L. Using the original number N is accomplished by using the traditional half-precision or full-precision floating-point (FP) operations without modification.

For example, the number N can be represented as:

$$N = ( 1.0 + M ) \times {2}^{E - B}$$

In IEEE754 32-bit format, E is a non-negative 8-bit integer, B is a constant value 127, and M is the 23-bit mantissa. If the base-2 logarithm is taken, L may be presented as follows:

$$L = {log}_{2} N = {log}_{2} ( 1 + M ) + E - B$$

M is a value that between 0 and 1. This is important to note because of this approximation:

$${log}_{2} ( 1 + M ) \approx M + C$$

Where factor C is a correction factor (referred to herein also as Mu).

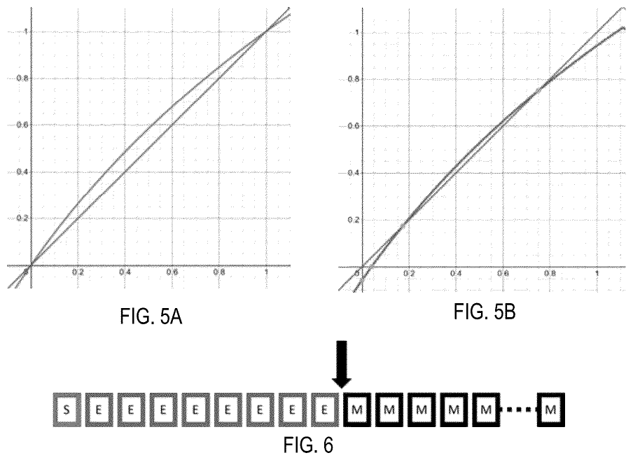

This is shown graphically for two possible values of C in FIGS. 5A and 5B. FIGS. 5A and 5B depict graphs with two possible values of C for the above example. FIG. 5A is a plot of log₂(1+X) and X+C where C=0 in an example. FIG. 5B is a plot of log₂(1+X) and X+C where C=0.0473 in an example.

In various embodiments, there are two methods to minimize error: minimizing the maximum error or minimizing the average error. While minimizing the maximum error will place a boundary on calculations that depend on L, minimizing the average error over all possible fractional values provides better ML model accuracy results. As a result, L can be represented as:

$$L = E - B + M + C$$

Another example of a logarithmic value (sign ignored) is given in the (E+M+1) bit format which may correspond to

$$L ( val ) = e - B + \frac{( m + MU )}{{2}^{M}} .$$

E=number/>of bits, e=value in binary. M=number of bits, and m=value in binary. B is the bias for the e portion and Mu is the bias for the lower portion. E−B+(M+Mu)/(2^M) shifted right by M bits. E bits is in a first register M bits is in second register. When divided by 2 to the M, it shifts it right by m bits.

The value E+M may represent the logarithm of N plus the bias, minus the correction factor. This follows the previous equation:

$$L + B - C = E + M$$

Again, correction factor “C” is Mu. Based on this approximation, the FPLNS binary representation of L may be defined as a fixed-point format layered on top of the IEEE754 format using the same 32 bits as shown in FIG. 6. FIG. 6 is an example of a FPLNS format with a radix point defined at the arrow for the fixed-point base-2 logarithm. The bias/correction is an implied constant. Therefore, the floating-point format when viewed differently provides a method for operating on the logarithm. It will be appreciated that the biasing factor B and correction factor C (both constants) may be accounted for.

As follows, it is now possible to define multiplication and division in terms of the approximate logarithms:

$${N}_{1} \times {N}_{2} = {L}_{1} + {L}_{2} + B - C = {M}_{1} + {E}_{1} + {M}_{2} + {E}_{2} - B + C$$

In various embodiments, in order to compute the product of N₁ and N₂, an example algorithm may use uses the following steps:
1. Separate the sign bits S₁, and S₂.
2. Sum the bottom n-1 bits using fixed-point (integer) addition.
3. Add the precomputed constant (B-C) in fixed-point format.
4. Compute the sign bit S=S₁⊕S₂

This algorithm may have an effective linear complexity with respect to the number of bits. As a corollary, the division algorithm can be defined the same way as per the following equation:

$$\frac{{N}_{1}}{{N}_{2}} = {L}_{1} - {L}_{2} - B + C$$

While not essential to a large number of recent machine learning models, division may be useful when defining activation functions like softmax and ReLU.

The FPLNS architectural model is not limited to 32-bit floating-point but may be generalized to arbitrary levels of precision in both floating-point and integer formats. While values of B and C are specified for FP32 floating-point here, it is possible to derive new values for FP16, and BF16. FPLNS computation of INT8 multiplication is possible if int-float conversion is used.

The FPLNS system 200 comprises an input module 202, an addition module 204, a multiplication module 206, a division module 208, a log module 210, an exponentiation module 212, a higher order module 214, and a datastore 216. The FPLNS system 200 may be implemented by an FPLNS multiplier (e.g., a hardware FPLNS multiplier integrated into an integrated circuit such as depicted in FIG. 1). In some embodiments the FPLNS system 200 may control a processor, multiplier (e.g., FPLNS multiplier), and/or the like to perform any of the FPLNS functions described herein. In some embodiments, a processor may access registers while the FPLNS multiplier performs FPLNS functions or assists in performing FPLNS functions.

Returning to FIG. 2, the FPLNS system 200 includes the input module 202 which may optionally organize or store data using the FPLNS data format depicted in FIGS. 3 and 4. The input module 202 may sort the exponent bits in order of size, such that the highest exponent bit 322 of the exponent bits 320 is closest to the sign bit 310 and the lowest exponent bit 324 is closest to the mantissa bits 330 (as shown in FIG. 3). Similarly, the input module 302 may sort the mantissa bits 330 in order of size such that the highest mantissa bit 332 of the mantissa bits is closest to the exponent bits and the lowest mantissa bit 334 is farthest from the exponent bits.

Similarly, referring to FIG. 4, the input module 202 may sort the exponent bits in order of size such that the highest exponent bit 452 of the exponent bits 450 is closest to the sign bit 440 and the lowest exponent bit 454 is closest to the mantissa bits (as shown in FIG. 4). Similarly, the input module 202 may sort the mantissa bits 460 in order of size such that the highest mantissa bit 462 of the mantissa bits is closest to the exponent bits and the lowest mantissa bit 464 is farthest from the exponent bits

The input module may receive and/or convert any amount of data into the FPLNS format.

In various embodiments, the input module 202 may optionally convert floating-point binary values (e.g., in the FPLNS format) to logarithmic binary values. For example, the input module 202 may: (1) take the base-2 logarithm of a quantity of one plus a mantissa of the first floating-point binary value to form a first log quantity, (2) add the first log quantity to the exponent of the first floating-point binary value to form a first total, and (3) subtract a constant bias from the first total to form the logarithmic binary value. In one example, a logarithmic binary value of a floating-point binary value is log₂(1+M)+E−B. In another example, the input module 202 may generate a logarithmic binary value by the following:

$$L ( val ) = e - B + \frac{( m + MU )}{{2}^{M}}$$

where e=exponent value in binary, M=number of bits of the mantissa, and m=mantissa value in binary, B is the constant bias (e.g., B=2^{(E-1)}−1, where E=number of bits of the exponent), and MU is the correction factor C. The correction factor MU may be a constant depending on usage or a variable (e.g., provided by a user and/or taken from a register). In one example, MU is a value such as 0.043. MU is between 0.0 to 9.9. In some embodiments MU is between 0.04 to 0.06.

For machine learning, rough approximations can be used (e.g., no newton's methods) because the degree of accuracy is not necessary (e.g., for classification, mean square error for FPLNS softmax is on the order of 0.0003). In some embodiments, for resnet 18 (mu of 0.0) provides a loss of 4-6%.

The addition module 204 may perform addition any two binary values or two logarithmic values. In some embodiments, the FPLNS system shares the same floating-point addition operation of IEEE 754. Addition and subtraction may be calculated using the standard floating-point addition operations so there is no loss of accuracy. This is a benefit as addition accuracy has been shown to be more important than multiplication accuracy in its effects on ML models.

IEEE754 Floating-point (FP) and FPLNS share similar addition operations. The same exception flags also used: nan (not a number), inf (infinity), ov (overflow), uf (underflow), ze (zero).

The multiplication module 206 may perform multiplication of two binary values or two logarithmic values (the multiplication function being referred to herein as fplns mult (first value, second value)). The multiplication module 206 manages multiplication functions (referred to herein as fplns mult(value1, value 2)). In one example, given numbers a,b in floating-point and corresponding L(x) and L(y) logarithms in FPLNS format:

$$p = x * y [ actual multiplication ]$$

$$L ( p ) = L ( x ) + L ( y ) - ( B ≪ M ) + MU [ fplns mul ( x , y ) ]$$

In this example, the sign bit is dropped and these are fixed-point addition/subtraction operations. (B<<M) is constant and MU may be variable or constant. Note that biased forms of L(x) and L(y) require zero computation

There may be optimized implementations with constant MU and variable MU. In some embodiments, the multiplication module 208 may use commutative and associative properties of addition/subtraction to find equivalent circuits.

In some embodiments, Sign bit p.s=XOR(x.s,y.s) (i.e., exclusive or of sign bits from x and y).

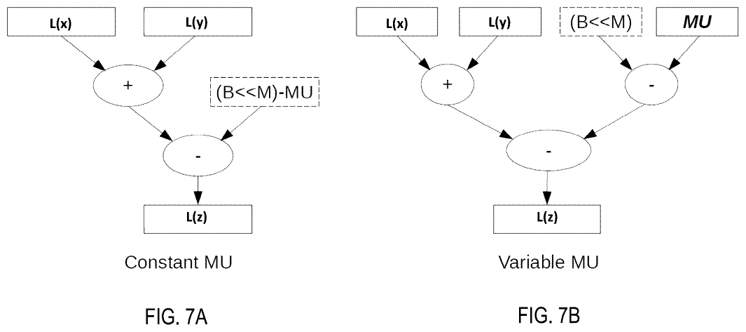

As discussed herein, in some embodiments, the sign bit is dropped and the multiplication module 206 utilizes fixed-point addition/subtraction operations. FIG. 7A depicts a flowchart for multiplying two logarithmic binary values using the FPLNS process where the correction factor MU is a constant. FIG. 7B depicts a flowchart for multiplying two logarithmic binary values using the FPLNS process where the correction factor MU is a variable. In some embodiments, the biased forms of L(x) and L(y) require zero or little computation.

It will be appreciated that when MU is a constant, a constant for MU may be encoded or based on the process being performed (e.g., a particular MU for softmax functionality and another MU for a different function). When MU is variable, the multiplication module 206 may retrieve MU from a register (e.g., a first register may hold the first logarithmic binary value to be multiplied, a second register may hold the second logarithmic binary value to be multiplied, and the third register may hold a value representing MU). In some embodiments, a user may provide MU to be used (e.g., through code or within an interface).

In FIG. 7A, the first logarithmic binary value L(x) is added to second logarithmic binary value L(y). B, the constant bias as defined above, is shifted by the number of bits in the mantissa (e.g., the mantissa of the first and/or second floating-point binary values to be multiplied). After shifting, constant MU is subtracted from the constant bias B to generate a corrected bias value. The corrected bias value is subtracted from the sum of the first logarithmic binary value L(x) and the second logarithmic binary value L(y) to generate L(Z) (i.e., the antilog of Z will produce the product of the two binary values).

In FIG. 7B, the first logarithmic binary value L(x) is added to second logarithmic binary value L(y). B, the constant bias as defined above, is shifted by the number of bits in the mantissa (e.g., the mantissa of the first and/or second floating-point binary values to be multiplied). After shifting, variable MU is subtracted from the constant bias B to generate a corrected bias value. In this example, variable MU may be retrieved from a memory register. The corrected bias value is subtracted from the sum of the first logarithmic binary value L(x) and the second logarithmic binary value L(y) to generate L(Z) (i.e., the antilog of Z will produce the product of the two binary values).

In some embodiments, the multiplication module 206 may use commutative and/or associative properties of addition/subtraction to find equivalent circuits.

The division module 208 may perform division in some embodiments (the division function referred to as fplns div (value 1, value 2) herein). Again, the division module 208 uses the logarithmic representation. Given numbers a and b in floating-point and the corresponding L(x) and L(Y) logarithms in FPLNS format, q=x/y (actual division) and L(q)=L(x)−L(y)+(B<<M)−MU.

In various embodiments, the sign bit is dropped and these ae fixed-point addition/subtraction operations. Bias factor B is a constant (i.e., B<<M or B shifted based on the number of bits in the mantissa of the floating-point binary value is always constant). MU may be a constant or a variable as discussed with regard to the multiplication module 206. As discussed herein, the biased forms of L(x) and L(y) require zero or little computation.

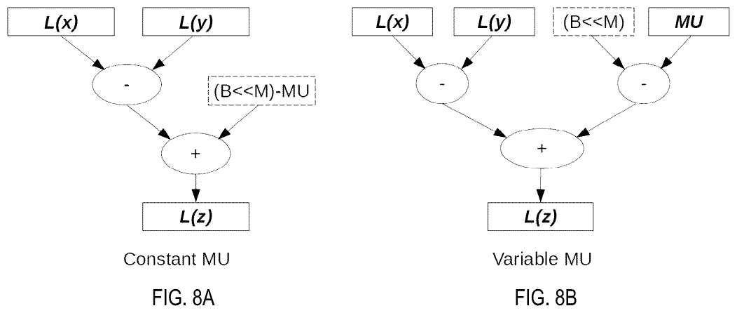

FIG. 8A depicts a flowchart for dividing two logarithmic binary values using the FPLNS process where the correction factor MU is a constant. In FIG. 8A, the first logarithmic binary value L(x) is subtracted from a second logarithmic binary value L(y). B, the constant bias as defined above, is shifted by the number of bits in the mantissa (e.g., the mantissa of the first and/or second floating-point binary values to be divided). After shifting, constant MU is subtracted from the constant bias B to generate a corrected bias value. The corrected bias value is added to the difference of the first logarithmic binary value L(x) and the second logarithmic binary value L(y) to generate L(Z) (i.e., the antilog of L(Z) will be the division of the two binary values).

FIG. 8B depicts a flowchart for dividing two logarithmic binary values using the FPLNS process where the correction factor MU is a variable. In FIG. 8B, the first logarithmic binary value L(x) is subtracted from the second logarithmic binary value L(y). B, the constant bias as defined above, is shifted by the number of bits in the mantissa (e.g., the mantissa of the first and/or second floating-point binary values to be divided). After shifting, variable MU is subtracted from the constant bias B to generate a corrected bias value. In this example, variable MU may be retrieved from a memory register. The corrected bias value is added to the difference of the first logarithmic binary value L(x) and the second logarithmic binary value L(y) to generate L(Z) (i.e., the antilog of L(Z) will be the division of the two binary values).

In some embodiments, the division module 208 may use commutative and/or associative properties of addition/subtraction to find equivalent circuits.

The log module 210 converts a biased, fixed-point number to a floating-point number. In one example (the function referred to herein as fplns log2 (variable)), given values x and L(x) in the FPLNS format, L(x) in this example is a 31 bit biased, fixed-point number with a sign bit (the sign bit is not a part of the 31 bit value). In the next step, the log module 210 drops the sign bit so that |L(v)| (i.e., the absolute value of L(v)) is a 31-bit number. Variable u is defined as u=|L(v)|−((B<<M)—MU). In the second step, u is converted to the floating-point format where it is converted to sign bit s and |u| and then normalized to the floating-point format with sign bit s (e.g., using a priority encoder and adders that may be found in the prior art).

In some embodiments, the log module 210 may use commutative and/or associative properties of addition/subtraction to find equivalent circuits.

In some embodiments, the log module 210 may convert to logarithm base C. Given a variable C, then K is defined as either:
K=fpnlslog2(C) (the method used above regarding the log module 210 conversion of a biased, fixed-point number)
K=Log(2) in floating-point for constant C.

Given the input value v and u=fplnslog2(v) and assuming fplnslogC(x)=fplinsdiv(u,K). Here, fplinsdiv(u,K) refers to the process of division of u and K following the process depicted in flowcharts in FIG. 8A and 8B.

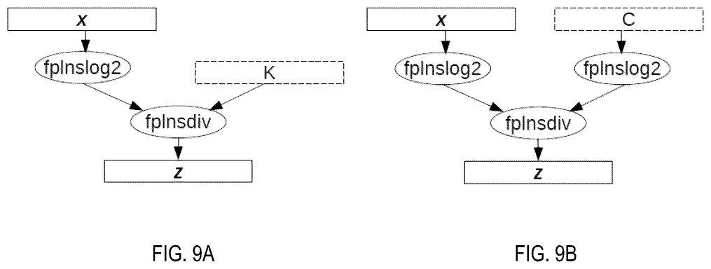

FIG. 9A depicts an example process of FPLNS logarithm base C in some embodiments. FIG. 9B depicts another example process of FPLNS logarithm base C in some embodiments. It will be appreciated that these flowcharts are equivalent when considering that fplns logC(x)=fplns div(u,K).

In FIG. 9A, the log module 210 takes fplns log2 of (x) (see above regarding fplns log2(value)). Subsequently the fplns log2 is divided with K to output z. As discussed herein, given values x and L(x) in the FPLNS format, L(x) in this example is a 31 bit biased, fixed-point number with a sign bit (the sign bit is not a part of the 31 bit value). In the next step, the log module 210 drops the sign bit so that |L(v)| (i.e., the absolute value of L(v)) is a 31-bit number. Variable u is defined as u=|L(v)|−((B<<M)−MU). In the second step, u is converted to the floating-point format where it is converted to sign bit s and |u| and then normalized to the floating-point format with sign bit s (e.g., using a priority encoder and adders that may be found in the prior art). The division module 208 divides the output of fplnslog2(x) with K (e.g., K may be retrieved from a register).

As depicted in FIG. 8A, the first logarithmic binary value L(x) is subtracted from a second logarithmic binary value L(K). B, the constant bias as defined above, is shifted by the number of bits in the mantissa (e.g., the mantissa of the first and/or second floating-point binary values to be divided). After shifting, constant MU is subtracted from the constant bias B to generate a corrected bias value. The corrected bias value is added to the difference of the first logarithmic binary value L(x) and the second logarithmic binary value L(y) to generate L(Z) (i.e., the division of the two binary values). If C is a variable, the flowchart depicted in FIG. 8B may be followed.

FIG. 9B is an equivalent process of FIG. 9A where fplns logC(x)=fplns div(u,K). In FIG. 9B, the log module 210 takes fplnslog2 of (x) in a manner similar to that described regarding FIG. 9A. Subsequently the fplns log2 is divided with fplns log2(C) to output z. As discussed herein, given values C and L(C) in the FPLNS format, L(C) in this example is a 31 bit biased, fixed-point number with a sign bit (the sign bit is not a part of the 31 bit value). In the next step, the log module 210 drops the sign bit so that |L(C)| (i.e., the absolute value of L(C)) is a 31-bit number. Variable u is defined as u=|L(C)|−((B<<M)—MU). In the second step, u is converted to the floating-point format where it is converted to sign bit s and |u| and then normalized to the floating-point format with sign bit s (e.g., using a priority encoder and adders that may be found in the prior art). The division module 208 divides the output of fplnslog2(x) with fplns log2(C) (e.g., C may be retrieved from a register).

Base-2 logarithms and base-2 exponents may be calculated by converting from fixed-point to floating-point, or vice-versa. In some embodiments, converting can be accomplished by accounting for the bias/correction then using priority encoder with a barrel shifter.

The exponentiation module 212 performs exponentiation. In one example, the exponentiation module 212 performs exponentiation base 2 (fplns exp2(value)). The exponentiation base 2 function is a conversion of a floating-point number to a biased, fixed-point number. Correction factor MU may be variable or constant.

Given v and L(v) in the FPLNS format, the exponentiation module 212 splits x into sign s, exponent e, and mantissa m. The mantissa m is fraction 0.m+(M−1) . . . m_0 such that m_i is bit i. Mantissa m′=1+m and SHAMT=e-B. If s==0 (if the s bit==0), then the final value is m′<<SHAMT)−MU) and if s==1, then the final value is fplnsdiv(1, ((m′<<SHAMT)−MU)). Left shift (<<) becomes right shift (>>) if SHAMT<0.

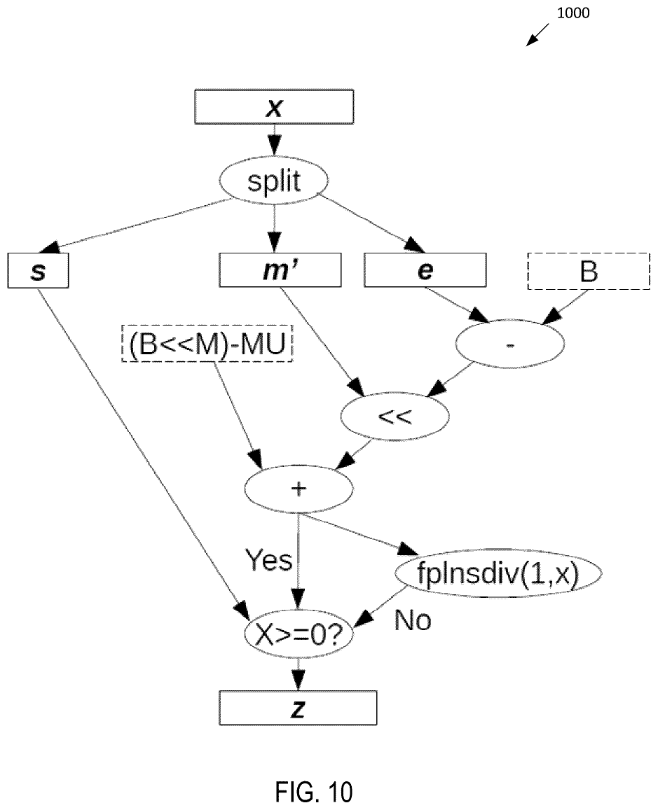

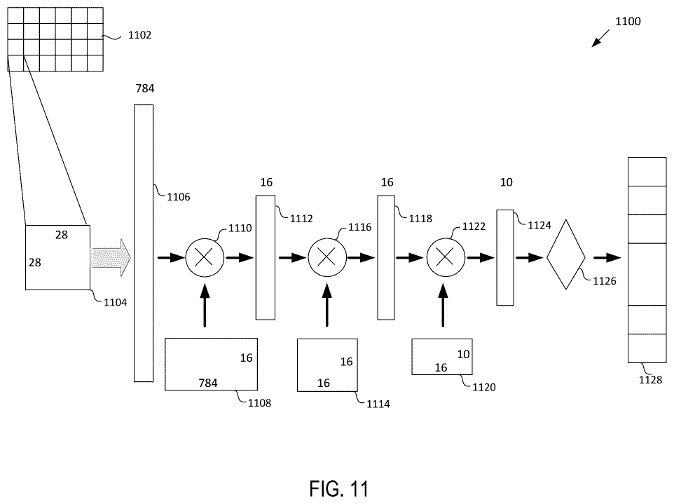

FIG. 10 depicts exponentiation process 1000 in some embodiments. Given x, the exponentiation module 212 may optionally split the sign bit, m′, and e from the fplns format of x. The process is optional in that the exponentiation module 212 may retrieve the information (and calculate m′) based on the information stored in the fplns storage format. The exponentiation module 212 may take the difference between exponent e and bias B (e.g., where B is a constant). The value m′ is shifted based on the difference of exponent e and bias B.

The exponentiation module 212 may shift B based on the bits of the mantissa and take the difference of correction factor Mu before adding the result to the shifted value m′ to form a first exponentiation value.

If the s bit is greater than or equal to 0, then the exponentiation value is output as z.

If the s bit is not greater than or equal to 0, then the division module 208 may divide (1, first exponentiation value) to output as z.

The square root module 214 may perform square root functions. In one example, the fplns square root function of (x)=fplns exp2 (fplns mult (0.5,fplnslog2(x))). Similarly, fplns square root function of (x)=fplns exp2(float(L(x)>>1)). 0.5 may be a constant. L(x) is the unbiased, fixed-point logarithm base 2. Shifting right by 1 is the same as division of integer by 2. In some embodiments, the fplns operations may be partially substituted with standard floating-point operations. Float(y) converts a fixed-point value y to floating-point.

The square root module 214 may also perform Nth root functions. For example, fplns root(x)=fplns exp2(fplns mul (1/n, fplns log2(x))) or fplns root(x)=fplns exp2(fplns div (fplns log 2 (x), n). 1/n may be a constant. In some embodiments, 1/n may be substituted with fplnsdiv (1, n) for variable n-th root.

In some embodiments, average error may be minimized due to log2(1+x) approximation by minimizing F(x, MU) with respect to MU. For example:

$$F ( x , μ ) = \frac{1}{1 - 0} {\int }_{0}^{1} {log}_{2} ( 1 + x ) - ( x + μ ) dx$$

Further, a maximum error due to log2(1+x) approximation can be minimized calculating MU. For example:

$$μ = \frac{1}{2} max [ {log}_{2} ( 1 + x ) - x ]$$

The FPLNS system may be used in many cases. The higher order module 214, in conjunction with other modules, may perform higher order functions. For example, the higher order module 214 may be utilized for deep learning primitive functions such as:
FPLNS 2D Convolution
FPLNS Batch Normalization
FPLNS Matrix Multiplication
FPLNS Sigmoid
FPLNS Average Pooling
FPLNS Softmax

Other functions that may be performed by the higher order module 214 using the functions discussed herein (e.g., fplns mult, fplns div, and the like) may include but are not limited to softplus, Gaussian, Guassian error linear unit (GELU), scaled exponential linear unit (SELU), leaky rectified linear unit (Leaky ReLU), Parametric rectified linear unit (PreLU), sigmoid linear unit (SiLU, Sigmoid shrinkage, SiL, or Swish-1), Mish, erf(x), hyperbolic cosine, hyperbolic sine, hyperbolic tangent, continuously differentiable exponential linear unit (CELU), Exponential Linear Unit (ELU), hard sigmoid, hard Swish, logarithmic softmax, and softsign.

The higher order module 214 may implement higher order functions as state machines or may pipeline processes. In some embodiments, the higher order module 214 may take advantage of Taylor expansion or Newton's method in performing one or more functions.

One or more of the fplns functions discussed herein may be utilized in any number of different functions or processes. In some embodiments, fplns functions may be utilized with accurate functions (e.g., in an ensemble approach depending on needs). Fplns functions, however, may perform many tasks more quickly with power savings than accurate functions or combinations of fplns and accurate functions.

For example, image processing may take advantage of fplns functions for improvements in speed, scaling, and power efficiency over the prior art, thereby improving upon the technical deficiencies of pre-existing technological solutions.

The datastore 216 may include any number of data structures that may retain functions. In various embodiments, functions discussed herein are implemented in hardware (e.g., using an fplns multiplier) within an integrated circuit and/or using an IP core.

FIG. 11 depicts an example process of classification 1100 utilizing fplns functions in some embodiments. In FIG. 11, a set of images 1102 may be received. In one example, the images 1102 is the Modified National Institute of Standards and Technology database (MNIST) image set from the MNIST database. The MNIST is a large database of handwritten digits ranging from 0 to 9 that is commonly used for training various image processing systems.

Matrix multiplication may be performed using fplns mult functions as discussed herein (i.e., fplns multiplication) for considerable improvements in speed, scaling, and power (especially when considering the number of times the multiplication function must be performed).

In this example, an image of 28×28 is taken in and converted into a one-dimensional array of 784.

In this simple example, the one-dimensional array of 784 is multiplied in step 1110 by a weighting matrix 1108 of 784×16 to produce a vector of 16 values 1112.

The vector of 16 values 1112 is similarly multiplied in step 1116 by a weighting matrix 1114 of 16×16 to produce a vector of 16 values 1118.

The vector of 16 values 1118 is similarly multiplied in step 1122 by a weighting matrix 1120 of 16×10 to produce a vector of 10 values 1124.

As discussed herein, each matrix multiplication function (e.g., in steps 1110, 1116, and 1122) may utilize fplns multiplication functions.

An activation function 1126 is performed on the vector of 10 values 1124 to create a vector of percentages which may then be used to classify the image 1104. Examples of multiplication functions may include a sigmoid function or a softmax function.

The sigmoid function may be as follows:

$$σ ( x ) = \frac{1}{1 + {e}^{- x}} .$$

In various embodiments, the fplns exponentiation function may be utilized in the denominator. Further, the fplns division function may be utilized. Alternately, there may be any combination of fplns functions and accurate functions. For example, the fplns exponentiation function may be used as well as an accurate division function. In another example, the fplns division function functions may be utilized with accurate exponentiation and/or addition.

The softmax function may be as follows:

$${f}_{i} ( \vec{x} ) = \frac{{e}^{x} i}{{\sum }_{j = 1}^{J} {e}^{{x}_{j}}} .$$

In various embodiments, the fplns exponentiation function may be utilized in the denominator and the numerator. Further, the fplns division function may be utilized. Alternately, there may be any combination of fplns functions and accurate functions. For example, the fplns exponentiation function may be used as well as an accurate exponentiation function. In another example, the fplns exponentiation functions may be utilized with accurate division and/or addition. Alternately, fplns division functions may be utilized with accurate exponentiation functions.

The fplns functions enable significant improvements in speed, scaling, power, and efficiency. The fplns functions also support a wide variety of high-level functions.

While accuracy of basic FPLNS arithmetic primitives may show significant inaccuracies, the net effect on several models is minimal as follows:

| | | | FPLNS | Accuracy |
|---|---|---|---|---|
| Model | Data set | Accuracy | Accuracy | Loss |
| Fully connected | MNIST | 87.5% | 87.4% | 0.1% |
| MobilNetV1 | MNIST | 98.46% | 98.19% | 0.27% |
| Resnet18 | ImageNet | 69.76%/ | 69.22%/ | 0.54%/ |
| | | 89.08% | 88.79% | 0.29% |
| Resnet50 | ImageNet | 76.13%/ | 75.22%/ | 0.91%/ |
| | | 92.86% | 92.56% | 0.30% |

In this example, four models have been implemented using approximate FPLNS primitives for multiplication, division, inverse square root, and exponentiation. The fully connected model, used as an initial test model, is a 3-level network that uses sigmoid activation functions. These models were trained in a traditional fashion using exact arithmetic for up to 200 epochs. Then, the models were tested for inference using both standard and FPLNS deep learning primitive layers. Only computation algorithms were changed. The weight quantization and model architectures were unmodified. The results demonstrate that FPLNS arithmetic is clearly competitive with an accuracy loss of less than 1% across all models tested. This is better than 8-bit quantization which has 1.5% accuracy loss for ResNet50.

Integer Quantization: If an integer is first converted to floating-point, then FPLNS techniques may be used to accelerate the INT8 multiplication or activation functions. In some embodiments, FPLNS systems and methods discussed herein may be utilized in ML models which use a mix of precision across multiple layers.

Weight Pruning/Clustering: It is possible to prune zero weights from the computation. Also, it is possible to combine a cluster of weights of nearly the same value into a single value then store it in a Huffman table. Both weight pruning and clustering techniques are methods for macro-level approximate model computation and both methods can be used in tandem with FPLNS computation to achieve even lower power consumption than pruning/clustering alone. FPLNS is not mutually exclusive to pruning/clustering.

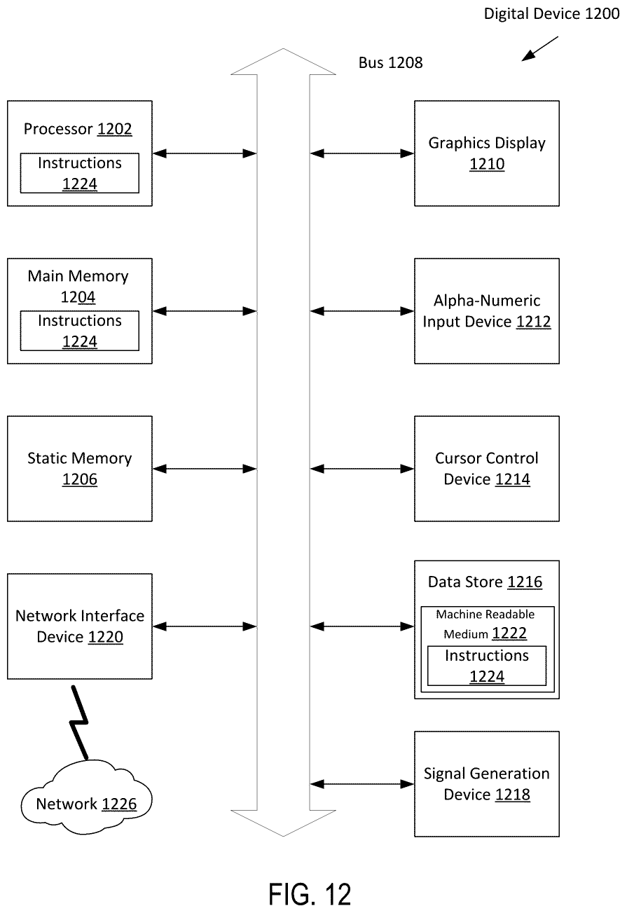

FIG. 12 is a block diagram illustrating a digital device capable of performing instructions to perform tasks as discussed herein. A digital device is any device with memory and a processor. Specifically, FIG. 12 shows a diagrammatic representation of a machine in the example form of a computer system 1200 within which instructions 1224 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1224 (sequential or otherwise) that specify actions to be taken by that machine. Further, while only a single machine is illustrated, the term “machine” shall also be taken to include any collection of machines that individually or jointly execute instructions 1224 to perform any one or more of the methodologies discussed herein.

The example computer system 1200 includes a processor 1202 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 1204, and a static memory 1206, which are configured to communicate with each other via a bus 1208. The computer system 1200 may further include a graphics display unit 1210 (e.g., a plasma display panel (PDP), a liquid crystal display (LCD), a projector, or a cathode ray tube (CRT)). The computer system 1200 may also include alphanumeric input device 1212 (e.g., a keyboard), a cursor control device 1214 (e.g., a mouse, a trackball, a joystick, a motion sensor, or other pointing instrument), a data store 1216, a signal generation device 1218 (e.g., a speaker), an audio input device (e.g., a microphone), not shown, and a network interface device 1220, which also are configured to communicate with a network 1226 via the bus 1208.

The data store 1216 includes a machine-readable medium 1222 on which is stored instructions 1224 (e.g., software) embodying any one or more of the methodologies or functions described herein. The instructions 1224 (e.g., software) may also reside, completely or at least partially, within the main memory 1204 or within the processor 1202 (e.g., within a processor's cache memory) during execution thereof by the computer system 1200, the main memory 1204 and the processor 1202 also constituting machine-readable media. The instructions 1224 (e.g., software) may be transmitted or received over a network (not shown) via the network interface 1220.

While machine-readable medium 1222 is shown in an example embodiment to be a single medium, the term “machine-readable medium” should be taken to include a single medium or multiple media (e.g., a centralized or distributed database, or associated caches and servers) able to store instructions (e.g., instructions 1224). The term “machine-readable medium” shall also be taken to include any medium that is capable of storing instructions (e.g., instructions 1224) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “engine” refers to computational logic for providing the specified functionality. An engine can be implemented in hardware, firmware, and/or software. Where the engines described herein are implemented as software, the engine can be implemented as a standalone program, but can also be implemented through other means, for example as part of a larger program, as any number of separate programs, or as one or more statically or dynamically linked libraries. It will be understood that the named engines described herein represent one embodiment, and other embodiments may include other engines. In addition, other embodiments may lack engines described herein and/or distribute the described functionality among the engines in a different manner. Additionally, the functionalities attributed to more than one engine can be incorporated into a single engine. In an embodiment where the engines as implemented by software, they are stored on a computer readable persistent storage device (e.g., hard disk), loaded into the memory, and executed by one or more processors as described above in connection with FIG. 12. Alternatively, hardware or software engines may be stored elsewhere within a computing system.

As referenced herein, a computer or computing system includes hardware elements used for the operations described here regardless of specific reference in FIG. 12 to such elements, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

1. A system comprising:
an integrated circuit including a hardware inexact floating-point logarithmic number system (FPLNS) multiplier configured to perform FPLNS functions, the integrated circuit configured to:
access registers containing a first floating-point binary value and a first logarithmic binary value of the first floating-point binary value, each of the first floating-point binary value and the first logarithmic binary value being in an FPLNS data format, the first floating-point binary value in the FPLNS format including a sign bit followed by exponent bits, the exponent bits followed by mantissa bits;
access registers containing a second floating-point binary value and a second logarithmic binary value of the second floating-point binary value, each of the second floating-point binary value and the second logarithmic binary value being in an FPLNS data format, the second floating-point binary value in the FPLNS format;
multiplying, by the FPLNS multiplier, the first floating-point binary value and the second floating-point binary value, the FPLNS multiplier configured to:
add, by the FPLNS multiplier, the first logarithmic binary value to the second logarithmic binary value to form a first logarithmic sum,
shift a bias constant by a number of bits of the mantissa of the first floating-point binary value to form a first shifted bias value,
subtract a correction factor from the first shifted bias value to form a first corrected bias value, and
subtract the first corrected bias value from the first logarithmic sum to form a first result; and
the integrated circuit being further configured to perform an antilogarithm on the first result to generate a multiplication result of the multiplication of the first floating-point binary value and the second floating-point binary value.
